(19) United States
(12) Patent Application Publication
(10) Pub. No.: US 2010/0117992 A1
(43) Pub. Date: May 13, 2010

(54) Touch System and Method for Obtaining Position of Pointer Thereof

(76) Inventor: Cho-Yi LIN, Hsinchu (TW)

Correspondence Address: HDLS Patent & Trademark Services, P.O. BOX 220746, CHANTILLY, VA, 20153-0746, US

(21) Appl. No.: 12/329,839

(22) Filed: Dec. 8, 2008

(30) Foreign Application Priority Data
Nov. 7, 2008 (TW) 097143217

(51) Int. Cl. G06F 3/042

(52) U.S. Cl. 345/176

(57) ABSTRACT

In a touch system and a method for obtaining a position of a pointer, the touch system includes a touch surface, at least three image sensing apparatuses and a processing circuit. A shape of the touch surface is a quadrilateral. The image sensing apparatuses are disposed at different comers of the touch surface and sensing areas of the image sensing apparatuses cooperatively cover the touch surface. The processing circuit is coupled to the image sensing apparatuses. When a pointer approaches the touch surface, the processing circuit takes each two of the image sensing apparatuses as one pair and detects a coordinate value of the pointer from images acquired by each pair of image sensing apparatuses. After at least two coordinate values have been detected, the processing circuit calculates the mean value of coordinate values of the pointer according to the detected coordinate values.

### BACKGROUND

1. Technical Field

The present invention generally relates to the field of touch technology and, more particularly, to a touch system and a method for obtaining a position of a pointer thereof.

2. Description of the Related Art

Referring to FIG. 1, a conventional touch system is shown. The touch system 100 includes a panel 110, image sensing apparatuses 120, 130 and a processing circuit 140. The panel 110 has a touch surface 112 and a shape of the touch surface 112 is a rectangle. The image sensing apparatuses 120 and 130 both are located at a same boundary of the touch surface 112 and disposed at different comers of the touch surface 112, so that sensing areas of the two image sensing apparatuses cooperatively cover the touch surface 112. In addition, the image sensing apparatuses 120 and 130 both are coupled to the processing circuit 140.

When a pointer 150 touches (or approaches) the touch surface 112, the image sensing apparatuses 120 and 130 can sense the pointer 150 respectively along the sensing lines 162 and 164 and transmit acquired images to the processing circuits 140. Subsequently, the processing circuit 140 finds out the sensing lines 162 and 164 according to the received images and calculate a coordinate value of the pointer 150 according to the two sensing lines. Thus, the detection of the coordinate value of the pointer 150 is realized.

However, since the processing circuit 140 detects the coordinate value of the pointer 150 only from the images acquired by the image sensing apparatuses 120 and 130, the detected coordinate value has a relative large error, resulting in the coordinate positioning for the touch system 100 is not accurate.

### BRIEF SUMMARY

The present invention relates to a touch system can achieve a relatively accurate coordinate positioning.

The present invention further relates to a method for obtaining a position of a pointer, adapted for a touch system having at least three image sensing apparatuses.

The present invention provides a touch system. The touch system includes a touch surface, at least three image sensing apparatuses and a processing circuit. A shape of the touch surface is a quadrilateral. The image sensing apparatuses are disposed at different corners of the touch surface and sensing areas of the image sensing apparatuses cooperatively cover the touch surface. The processing circuit is coupled to each of the image sensing apparatuses. When a pointer approaches the touch surface, the processing circuit takes each two of the image sensing apparatuses as one pair and detects a coordinate value of the pointer from images acquired by each pair of image sensing apparatuses, and after at least two coordinate values have been detected, the processing circuit calculates a mean value of coordinate values of the pointer according to the detected coordinate values.

The present invention further provides a method for obtaining a position of a pointer. The method is adapted for a touch system including a quadrilateral touch surface and at least three image sensing apparatuses. The image sensing apparatuses are disposed at different corners of the touch surface and sensing areas of the image sensing apparatuses cooperatively cover the touch surface. In this method, when a pointer approaches the touch surface, taking each two of the image sensing apparatuses as one pair and detecting a coordinate value of the pointer from images acquired by each pair of image sensing apparatuses. Subsequently, after at least two coordinate values have been detected, calculating the mean value of coordinate values of the pointer according to the detected coordinate values.

In one embodiment, the approach of calculating the mean value of coordinate values of the pointer is by way of performing arithmetic, geometric or harmonic means.

In one embodiment, the mean value of coordinate values of the pointer is calculated according to N coordinate values after the N coordinate values have been detected, the N is the amount of all possible pairs each of which is constituted by two of the image sensing apparatuses.

The present invention configures at least three image sensing apparatuses in a touch system, takes each two of the image sensing apparatuses as one pair and detects a coordinate value of a pointer from images acquired by each pair of image sensing apparatuses; and after at least two coordinate values have been detected, calculates the mean value of coordinate values of the pointer according to the detected coordinate values. Accordingly, compared with the prior art, the touch system in accordance with the present invention can achieve more accurate coordinate positioning.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a conventional touch system.

FIG. 2 is a schematic view of a touch system in accordance with an embodiment of the present invention.

FIG. 3 shows the pointer is situated on a diagonal line of the touch surface in accordance with the embodiment of the present invention.

FIG. 4 is a schematic view of a touch system in accordance with another embodiment of the present invention.

FIG. 5 is a trimetric view of a touch system in accordance with still another embodiment of the present invention.

FIG. 6 shows an image sensing apparatus adapted for matching with the reflector of FIG. 5 in use.

FIG. 7 is a schematic view of an image acquired by the image sensing apparatus of FIG. 5.

FIG. 8 shows primary steps of a method for obtaining a position of a pointer, in accordance with an embodiment of the present invention.

FIG. 9 is a schematic diagram of a touch system detecting a coordinate value of a pointer.

FIG. 10 is a schematic diagram of obtaining a linear equation of a sensing line.

FIG. 11 is a schematic diagram of obtaining a linear equation of a sensing line.

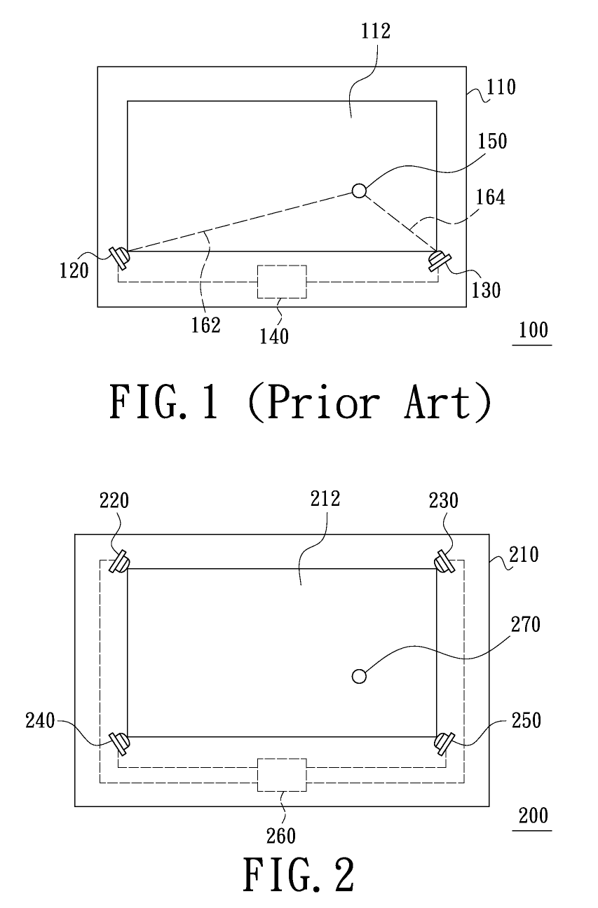

### DETAILED DESCRIPTION

Referring to FIG. 2, a touch system in accordance with an embodiment of the present invention is shown. The touch system 200 includes a panel 210, image sensing apparatuses 220, 230, 240 and 250 and a processing circuit 260. The panel 210 has a touch surface 212 of which a shape is a quadrilateral. In this embodiment, the shape of the touch surface 212 is a rectangle. The image sensing apparatuses 220, 230, 240 and 250 are disposed at different corners of the touch surface 212, so that sensing areas of the four image sensing apparatuses 220, 230, 240 and 250 cooperatively cover the touch surface 212. In addition, the image sensing apparatuses 220, 230, 240 and 250 all are coupled to the processing circuit 260.

When a pointer 270 touches (or approaches) the touch surface 212 and the image sensing apparatuses 220, 230, 240 and 250 can sense the pointer 270, the four image sensing apparatuses respectively transmit images acquired by themselves to the processing circuit 260. Subsequently, the processing circuit 260 takes each two of the image sensing apparatuses 220, 230, 240 and 250 as one pair and detects a coordinate value of the pointer 270 from the images acquired by each pair of image sensing apparatuses. After six coordinate values of the pointer 270 have been detected, the mean value of coordinate values of the pointer 270 is calculated according to the six detected coordinate values. The mean value is determined as the coordinate value of the pointer position. The above-mentioned amount of six is the amount of all possible pairs each of which is constituted by two of the four image sensing apparatuses, and detailed description will be described as follows.

Assuming that the coordinate value of the pointer 270 detected by the processing circuit 260 from the images acquired by the image sensing apparatuses 220 and 230 is (x₁, y₁), the coordinate value of the pointer 270 detected by the processing circuit 260 from the images acquired by the image sensing apparatuses 230 and 250 is (x₂, y₂), the coordinate value of the pointer 270 detected by the processing circuit 260 from the images acquired by the image sensing apparatuses 250 and 240 is (x₃, y₃), the coordinate value of the pointer 270 detected by the processing circuit 260 from the images acquired by the image sensing apparatuses 240 and 220 is (x₄, y₄), the coordinate value of the pointer 270 detected by the processing circuit 260 from the images acquired by the image sensing apparatuses 220 and 250 is (x₅, y₅), and the coordinate value of the pointer 270 detected by the processing circuit 260 from the images acquired by the image sensing apparatuses 230 and 240 is (x₆, y₆), the processing circuit 260 will calculate the mean value of coordinate values of the pointer 270 according to the six detected coordinate values.

The processing circuit 260 calculates the mean value of coordinate values of the pointer 270 by way of performing arithmetic, geometric, harmonic means or other algorithm. In terms of the arithmetic means, the mean value of the six coordinate values on X-axis direction and the mean value of the six coordinate values on Y-axis direction respectively are expressed by the following equations (1) and (2):

xₑ=(x₁+x₂+x₃+x₄+x₅+x₆)/6 (1)

yₑ=(y₁+y₂+y₃+y₄+y₅+y₆)/6 (2)

where: xₑ and yₑ respectively are the mean value on X-axis direction and the mean value on Y-axis direction, and the mean value of coordinate values of the pointer 270 is (xₑ, yₑ) correspondingly. In addition, in terms of the geometric means, the mean value on X-axis direction and the mean value on Y-axis direction of the six coordinate values respectively are expressed by the following equations (3) and (4):

x_{g}=⁶\sqrt{x₁×x₂×x₃×x₄×x₅×x₆} (3)

y_{g}=⁶\sqrt{yᵢ×y₂×y₃×y₄×y₅×y₆} (4)

where: x_{g} and y_{g} respectively are the mean value on X-axis direction and the mean value on Y-axis direction, and the mean value of coordinate values of the pointer 270 is (x_{g}, y_{g}) correspondingly. Moreover, in terms of the harmonic means, the mean value on X-axis direction and the mean value on Y-axis direction of the six coordinate values are respectively expressed by the following equations (5) and (6):

xₕ=6/((1/x₁)+(1/x₂)+(1/x₃)+(1/x₄)+(1x₅)+(1/x₆)) (5)

yₕ=6/((1/y₁)+(1/y₂)+(1/y₃)+(1/y₄)+(1/y₅)+(1y/₆)) (6)

where: xₕ and yₕ respectively are the mean value on X-axis direction and the mean value on Y-axis direction, and the mean value of coordinate values of the pointer 270 is (xₕ, yₕ) correspondingly.

Accordingly, since the processing circuit 260 can detect six coordinate values of the pointer 270 from the image acquired by the six pairs of image sensing apparatuses and calculates out the mean value of the six coordinate values, so that the positioning of the pointer 270 exists a relatively small error, the coordinate positioning for the present touch system is more accurate with respect to that of the prior art.

Although in the above-mentioned embodiment, the effect of reducing positioning error is achieved by detecting six coordinate values of the pointer 270 from the images acquired by six pairs of image sensing apparatuses and then calculating the mean value of the six coordinate values, a similar effect also can be achieved by detecting at least two coordinate values of the pointer 270 and then calculating the mean value of the at least two coordinate values. Moreover, the amount of the image sensing apparatuses is not limited to four, as long as the touch system 200 has at least three image sensing apparatuses, the mean value of coordinate values of the pointer 270 still can be calculated.

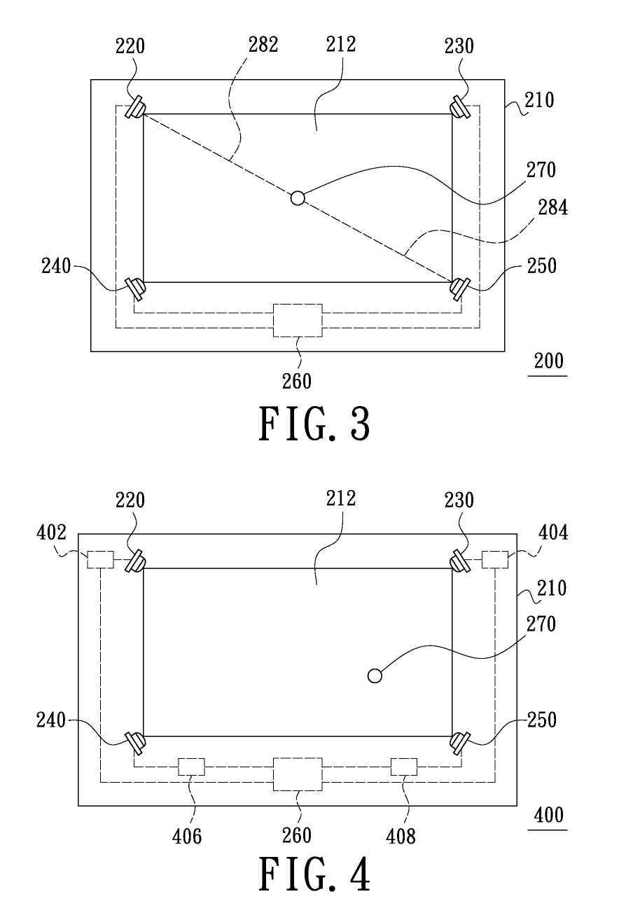

It is noted that, in the framework as illustrated in FIG. 2, when the approach of the processing circuit 260 detecting a coordinate value of the pointer 270 from images acquired by one pair of image sensing apparatuses is by way of calculating an intersection point of two sensing lines of the pair of image sensing apparatuses, the situation illustrated in FIG. 3 ought to be taken in consideration. FIG. 3 shows the pointer 270 situates on a diagonal line of the touch surface 212. As illustrated in FIG. 3, in this situation, the sensing line 282 of the image sensing apparatus 220 and the sensing lines 284 of the image sensing apparatus 250 have no intersection point. Accordingly, when the processing circuit 260 calculates the mean value of coordinate values of the pointer 270, the images acquired by the pair of image sensing apparatuses 220, 250 would be excluded.

Likewise, if the pointer 270 illustrated in FIG. 3 not only situates on the diagonal line between the image sensing apparatuses 220 and 250, but also the diagonal line between the image sensing apparatuses 230 and 240, when the processing circuit 260 calculates the mean values of coordinate values of the pointer 270, the images acquired by the two pairs of image sensing apparatuses would be excluded correspondingly. In a similar way, even if the touch system 200 only has three image sensing apparatuses or has more than four image sensing apparatuses, the above-mentioned exceptional situation also ought to be taken in consideration.

FIG. 4 is a schematic view of a touch system in accordance with another embodiment of the present invention. A difference of the touch system 400 as illustrated in FIG. 4 with respect to the touch system 200 as illustrated in FIG. 2 is that the touch system 400 further includes four subsidiary processing circuits having an amount identical with that of the image sensing apparatuses 220, 230, 240 and 250 and respectively labeled by 402, 404, 406 and 408. Each of the subsidiary processing circuits 402, 404, 406 and 408 is coupled between one of the image sensing apparatuses and the processing circuit 260 and for preprocessing the image data acquired by the image sensing apparatus, to facilitate the processing circuit 260 to detect the coordinate value of the pointer 270 according to the preprocessed image data from the subsidiary processing circuit.

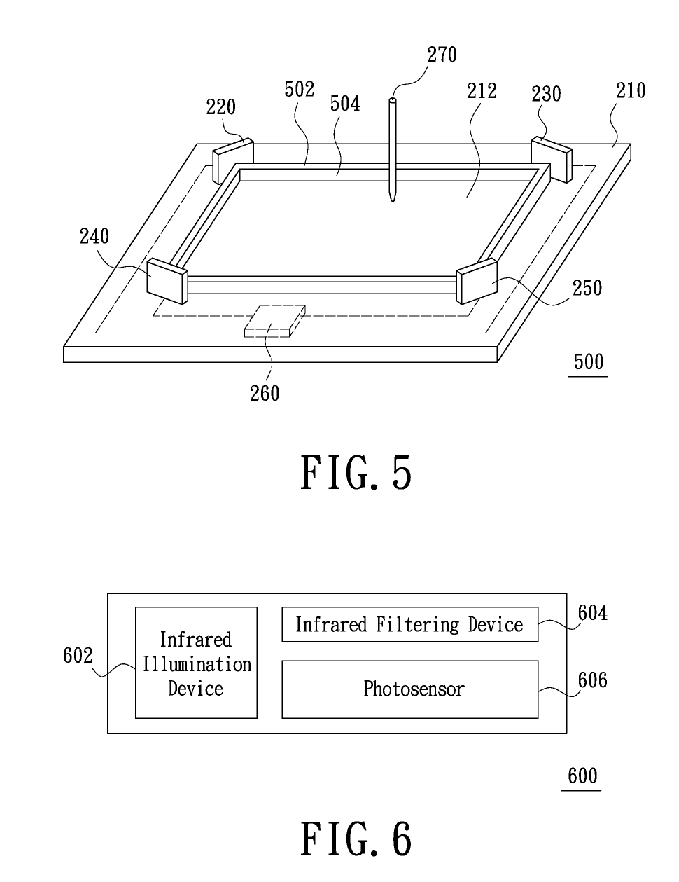

FIG. 5 is a trimetric view of a touch system in accordance with still another embodiment of the present invention. Referring to FIG. 5, the touch system 500 has a structural configuration similar to that of the touch system 200 as illustrated in FIG. 2 and further includes a reflector 502. The reflector 502 is disposed on the touch surface 212 and surrounds the touch surface 212. An inner margin of the reflector 502 has a reflective material 504, e.g., a retro-reflective material.

FIG. 6 illustrates an image sensing apparatus adapted for matching with the reflector 502 of FIG. 5 in use. Referring to FIG. 6, the image sensing apparatus 600 includes an infrared illumination device 602, an infrared filtering device 604 only allowing infrared light to pass therethrough, and a photosensor 606. The photosensor 606 acquires an image of the touch surface through the infrared filtering device 604. In addition, the infrared illumination device 602 can include an infrared light emitting diode (LED), and the infrared filtering device 604 can be an infrared-pass (IR-pass) filter.

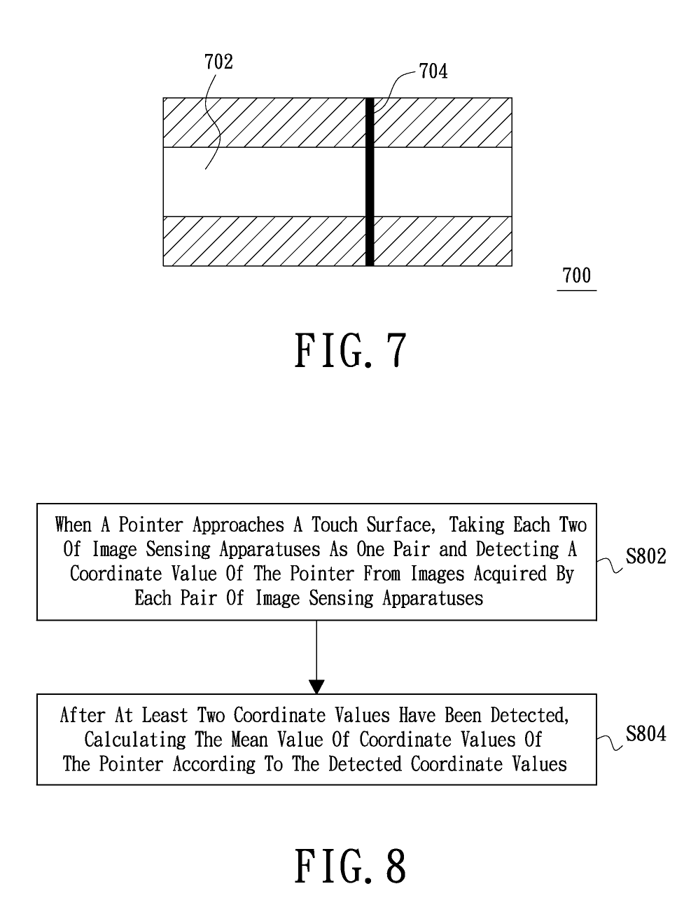

Assuming that the image sensing apparatus 240 of FIG. 5 uses the structural configuration of the image sensing apparatus 600 in FIG. 6 and the infrared illumination device normally operates, an image acquired by the image sensing apparatus 240 is the same as illustrated in FIG. 7. FIG. 7 is a schematic view of the image acquired by the image sensing apparatus 240 of the FIG. 5. In FIG. 7, the label 700 represents an image sensing window of the image sensing apparatus 240. The label 702 represents a bright zone which has a relatively high brightness and is formed on the image by the rays reflected by the reflective material 504 of the reflector 502, and the bright zone 702 is a main sensing area. The label 704 represents a black strip caused by the pointer 270. Therefore, the reflective material 504 is used as a main background of the pointer 270 when the image sensing apparatus 240 acquires the image of the touch surface 212, so as to highlight the position of the pointer 270.

According to the teachings of the above-mentioned embodiments, as illustrated in FIG. 8, a method for obtaining a position of a pointer can be extracted therefrom. FIG. 8 illustrates primary steps of a method for obtaining a position of a pointer in accordance with an embodiment of the present invention. The present method is adapted for a touch system having a quadrilateral touch surface and at least three image sensing apparatuses. The image sensing apparatuses are disposed at different comers of the touch surface and sensing areas of the image sensing apparatuses cooperatively cover the touch surface. In the present method, when a pointer approaches the touch surface, each two of the image sensing apparatuses are taken as one pair and a coordinate value of the pointer is detected from images acquired by each pair of image sensing apparatuses (as shown in step S802). Subsequently, after at least two coordinate values have been detected, the mean value of coordinate values of the pointer is calculated according to the detected coordinate values (as shown in step S802).

Of course, as illustrated in the foregoing embodiments, the approach for calculating the mean value of the coordinate values is by way of performing arithmetic, geometric or harmonic means. In addition, the mean value of the coordinate values is calculated after N coordinate values of the pointer have been detected and according to the N coordinate values. The N is the amount of all possible pairs each of which is constituted by two of all the image sensing apparatuses.

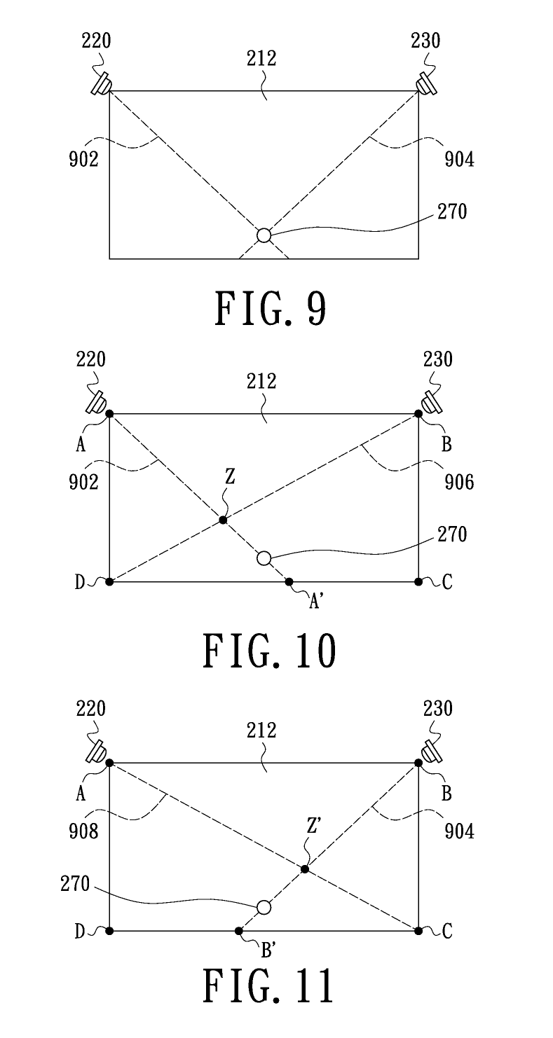

It is indicated that, there are various different methods can be used to detect a coordinate value of the pointer according to images acquired by two image sensing apparatuses, for example, the method is proposed by U.S. Pat. No. 4,782,328. Furthermore, another method will be described as follows so as to give the system designer much more choices. Referring to FIG. 9, being a schematic diagram of the touch system detecting a coordinate value of the pointer. As illustrated in FIG. 9, the labels 220 and 230 represent image sensing apparatuses, the label 212 represents a quadrilateral touch surface, and the label 270 represents a pointer. The image sensing apparatuses 220 and 230 sense the pointer 270 respectively along sensing lines 902 and 904. Accordingly, as long as linear equations of the two sensing lines are obtained, an intersection point of the two sensing lines can be obtained as the coordinate value of the pointer 270. More detailed description will be described with reference to FIGS. 10 and 11.

FIG. 10 is a schematic diagram of obtaining the linear equation of the sensing line 902. As illustrated in FIG. 10, in order to obtain the linear equation of the sensing line 902, coordinate values of points A and A′ are needed to be firstly acquired. Since the size of the touch surface 212 is fixed, the coordinate values of the points A, B, C and D are known while the X-axis coordinate value of point A′ is unknown. Therefore, an imaginary line 906 can be provided between the points B and D, and an intersection point of the sensing line 902 with the imaginary line 906 is point Z. Accordingly, line sections A̅B̅, B̅Z̅ and Z̅A̅ constitute a triangle, and line sections D̅A̅′̅, A̅′̅Z̅ and Z̅D̅ constitute another triangle. The two triangles are similar triangles and have a proportional relationship. Subsequently, since a resolution of the image sensing apparatus 220 is known, a length ratio of the line sections B̅Z̅ and Z̅D̅ of the imaginary line 906 can be acquired according to the pixel amounts of the respective line sections B̅Z̅ and Z̅D̅. Since the line sections A̅B̅ and D̅A̅′̅ have the same length ratio with respect to the length ratio of the line sections B̅Z̅ and Z̅D̅, and the length of the line section A̅B̅ is known, so that the length of the line section D̅A̅′̅ can be worked out and the X-axis coordinate value of the point A′ is obtained correspondingly. Finally, the linear equation of the sensing line 902 can be obtained according to the coordinate values of the points A and A′.

Likewise, as illustrated in FIG. 11, the linear equation of the sensing line 904 can be obtained by using a similar method as above described. FIG. 11 is a schematic diagram of obtaining the linear equation of the sensing line 904. Referring to FIG. 11, the label 908 represents an imaginary line, point Z′ is the intersection point of the sensing line 904 and the imaginary line 908. Therefore, line sections A̅B̅, B̅Z̅′̅ and Z̅′̅A̅ constitute a triangle, and line sections B̅′̅C̅, C̅Z̅′̅ and Z̅′̅B̅′̅ constitute another triangle. The two triangles also are similar triangles and have a proportional relationship. Subsequently, a length ratio of the line sections C̅Z̅′̅ and Z̅′̅A̅ is acquired, a length of the line section B̅′̅C̅ then can be worked out and correspondingly the X-axis coordinate value of the point B′ is obtained. Accordingly, the linear equation of the sensing line 904 can be obtained according to the coordinate values of points B and B′. After the linear equations of the sensing lines 902 and 904 are obtained, the intersection point of the sensing lines 902 and 904 can be acquired.

In summary, the present invention configures at least three image sensing apparatuses in a touch system, takes each two of the image sensing apparatuses as one pair and detects a coordinate value of the pointer from images acquired by each pair of image sensing apparatuses; after at least two coordinate values have been detected, calculates the mean value of coordinate values of the pointer according to the detected coordinate values. Accordingly, compared with the prior art, the touch system in accordance with the present invention can achieve more actuate coordinate positioning.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A touch system comprising:
a touch surface, a shape of the touch surface being a quadrilateral;
at least three image sensing apparatuses, disposed at different corners of the touch surface and sensing areas of the image sensing apparatuses cooperatively covering the touch surface; and
a processing circuit coupled to the image sensing apparatuses,
wherein when a pointer approaches the touch surface, the processing circuit takes each two of the image sensing apparatuses as one pair and detects a coordinate value of the pointer from images acquired by each pair of image sensing apparatuses, and after at least two coordinate values have been detected, the processing circuit calculates a mean value of coordinate values of the pointer according to the detected coordinate values.

2. The touch system as claimed in claim 1, wherein the processing circuit calculates the mean value of coordinate values of the pointer by way of performing one of arithmetic, geometric and harmonic means.

3. The touch system as claimed in claim 1, wherein the processing circuit calculates the mean value of coordinate values of the pointer according to N coordinate values after the N coordinate values have been detected, the N is the amount of all possible pairs each of which is constituted by two of the image sensing apparatuses.

4. The touch system as claimed in claim 1, further comprising subsidiary processing circuits which have an amount identical with that of the image sensing apparatuses, wherein each of the subsidiary processing circuits is coupled between one of the image sensing apparatuses and the processing circuit and for preprocessing the image data acquired by the image sensing apparatus, to facilitate the processing circuit to detect the coordinate value of the pointer according to the preprocessed image data from the subsidiary processing circuit.

5. The touch system as claimed in claim 1, further comprising a reflector disposed on and surrounding the touch surface, an inner margin of the reflector has a reflective material.

6. The touch system as claimed in claim 1, wherein each of the image sensing apparatuses has an infrared illumination device.

7. The touch system as claimed in claim 6, wherein the infrared illumination device comprises an infrared light emitting diode.

8. The touch system as claimed in claim 6, wherein each of the image sensing apparatuses further has an infrared filtering device only allowing infrared light to pass therethrough, and each of the image sensing apparatuses acquires an image of the touch surface through the infrared filtering device thereof.

9. The touch system as claimed in claim 1, wherein the shape of the touch surface is rectangle.

10. A method for obtaining a position of a pointer, adapted for a touch system, wherein the touch system comprises a quadrilateral touch surface and at least three image sensing apparatuses, the image sensing apparatuses are disposed at different corners of the touch surface and sensing areas of the image sensing apparatuses cooperatively covers the touch surface, the method comprising:
when a pointer approaches the touch surface, taking each two of the image sensing apparatuses as one pair and detecting a coordinate value of the pointer from images acquired by each pair of image sensing apparatuses; and
after at least two coordinate values have been detected, calculating a mean value of coordinate values of the pointer according to the detected coordinate values.

11. The method as claimed in claim 10, wherein the mean value is calculated by way of performing one of arithmetic, geometric and harmonic means.

12. The method as claimed in claim 10, wherein the mean value is calculated according to N coordinate values after the N coordinate values have been detected, the N is the amount of all possible pairs each of which is constituted by two of the image sensing apparatuses.
